(19) United States
(12) Patent Application Publication
(10) Pub. No.: US 2008/0260683 A1
(43) Pub. Date: Oct. 23, 2008

(54) Rodenticide

(76) Inventors: Gary Raymond Bowman, New South Wales (AU); Gordon Francis Reidy, New South Wales (AU); Duncan McLeod Watson, New South Wales (AU)

Correspondence Address: FISH & RICHARDSON PC, P.O. BOX 1022, MINNEAPOLIS, MN, 55440-1022, US

(21) Appl. No.: 10/587,112

(22) PCT Filed: Jan. 7, 2005
(86) PCT No.: PCT/GB2005/000024

§ 371 Date: Aug. 15, 2006

(30) Foreign Application Priority Data
Jan. 30, 2004 (GB) 0401988.1

(51) Int. Cl. A01N 25/00; A01P 11/00

(52) U.S. Cl. 424/84

(57) ABSTRACT

The invention relates to the systemic insecticide fipronil in conjunction with a rodenticide used for manufacture of a bait composition to provide a lethal effect on fleas and/or ticks and a host rodent, following ingestion of the bait composition by the host rodent. Preferred rodenticides are brodifacoum, difethialone, flocoumafen, bromadiolone and mixtures thereof. The invention also relates to rodenticidal bait compositions and to a method of killing ticks and a host rodent by providing for ingestion to the rodent, a bait composition comprising an effective amount of a rodenticide and an acaricidally effective amount of fipronil.

### TECHNICAL FIELD

This invention relates to rodenticidal compositions containing systemic insecticides and in particular rodenticidal compositions containing the systemic insecticide fipronil (5-amino-3-cyano-1-(2,6-dichloro-4-trifluoro-methylphenyl)-4-trifluoromethylsulfinylpyrazole).

### BACKGROUND ART

Rodents are often host to a range of parasitic arthropods including fleas and ticks. These can generally move from one host to another and if no host is available, they can survive for extended periods until a new host can be found. The manner in which this occurs varies from species to species.

Fleas and ticks can be vectors of organisms causing a range of diseases such as Lyme disease, plague, Rocky Mountain spotted fever, Colorado tick fever, Kyansanur Forest disease, Kerneroyo, Powassan encephalitis, Russian spring-summer encephalitis, Crimean-Congo haemorrhagic fever, tick-borne encephalitis, Mediterranean spotted fever, boutonneuse fever, Q fever, North Asian tick typhus, Queensland tick typhus, murine typhus, tick-bite fever, tularaemia, relapsing fever, ehrlichiosis and babesiosis. Tick toxins may also result in paralysis of some hosts.

At the very least, ticks and fleas cause significant irritation and discomfort to a host animal.

When rodents are killed, the vector fleas and ticks seek a new host and may transfer to domestic stock, domestic pets and humans causing discomfort and spreading disease. It is desirable therefore to control parasitic arthropods in conjunction with controlling their host rodents.

Traditionally, insecticides are dusted or sprayed just before or just after rodenticide application or an insect powder is applied in a bait box where rodents enter to reach the rodenticide. Ensuring a lethal dose of insecticide to target fleas/ticks is difficult and the possibility of killing non-target insects is high.

### DISCLOSURE OF INVENTION

More convenient would be a combination of an insecticide and a rodenticide in a single bait, the insecticide becoming systemic (i.e. available in the blood of the host) after ingestion of the bait. It is desirable that the arthropods die before the host rodent or at least take on a lethal dose of insecticide to prevent successful transfer to a new host.

Many rodents are difficult to kill because they are naturally suspicious and will not easily take a bait. When incorporating an insecticide into a bait, the bait must remain sufficiently palatable so that the rodent will accept it and ingest a lethal dose. Accordingly, it is desirable to provide an insecticide in a rodenticide bait matrix that is sufficiently palatable so as to give effective rodenticidal as well as insecticidal activity.

The present invention relates to the systemic insecticide fipronil in conjunction with a rodenticide. It has now been found that high palatability of rodenticide/fipronil baits can be achieved so as to give effective rodenticidal and insecticidal activity as well as acaricidal activity.

Accordingly, in a first aspect, this invention provides use of an effective amount of a rodenticide and an insecticidally effective amount up to 200 ppm of fipronil in the manufacture of a bait composition for providing a lethal effect on fleas and a host rodent thereof, following ingestion of the bait composition by the host rodent.

In a second aspect, the present invention provides use of an effective amount of a rodenticide and an acaricidally effective amount up to 200 ppm of fipronil in the manufacture of a bait composition for providing a lethal effect on ticks and a host rodent thereof following ingestion of the bait composition by the host rodent.

In a third aspect, the present invention provides a method of killing ticks and a host rodent thereof, comprising providing for ingestion to said rodent, a bait composition comprising an effective amount of a rodenticide and an acaricidally effective amount up to 200 ppm of fipronil.

For effectiveness against fleas, amounts of fipronil of at least 1 ppm (ppm: parts per million=0.0001%=0.001 g active/kg of bait) may be present, preferably at least 2 and more preferably at least 10 ppm. For effectiveness against ticks, amounts of fipronil of at least 10 ppm may be present, preferably at least 15 ppm, more preferably at least 25 ppm and most preferably at least 40 ppm. The upper limit to the amount of fipronil in the composition will largely be dictated by issues of cost effectiveness and by the risk of inducing toxicosis in the target rodents. Bait with a fipronil concentration of above 200 ppm could cause symptoms of toxicosis in rodents, even in a single feed. It is not desirable for the fipronil to be present in such amount as it is likely to lead to bait shyness. The term “bait shyness” relates to the scenario where a rodent eats a sub-lethal amount of bait, feels sick and associates its sickness with the bait. Consequently, the rodent refuses to eat the bait again. Amounts of fipronil up to but not including levels sufficient to cause symptoms of toxicosis are within the scope of the invention. For economic reasons, lower levels may be selected. Amounts of about 40 ppm of fipronil are suitable against ticks and fleas, being insecticidally and acaricidally effective and generally cost effective.

### Rodenticides

The rodenticide is a subacute or chronic type rodenticide. These types of rodenticide are slow acting and typically take more than 12 hours, often up to 24 hours or longer, for the onset of symptoms of toxicosis to appear. This is necessary to allow sufficient time for fipronil to be absorbed into the blood of the rodent and for the parasitic arthropods to ingest a lethal dose.

The rodenticide is preferably a hydroxycoumarin or indane-dione anticoagulant. Such anticoagulant rodenticides include, but are not limited to, warfarin, diphacinone, difenacoum, chlorphacinone, flocoumafen, bromadiolone, brodifacoum, difethialone, pindone, coumatetralyl, coumafuryl and coumachlor.

Anticoagulants are suitable rodenticides for preventing bait shyness and for allowing sufficient time for the fipronil to be effective against parasitic arthropods. Anticoagulants minimise the risk of bait shyness because the time between eating bait and feeling sick is in the order of days rather than hours. The time from ingestion of a lethal dose to death is usually in the order of 4-10 days. This is too long a time between eating and the onset of illness for the rodent to make the association.

For the bait composition of the present invention, the rodenticide is preferably selected from the group consisting of brodifacoum, difethialone, flocoumafen, bromadiolone and mixtures thereof.

The rodenticide is preferably included in an amount sufficient to provide a lethal dose if a rodent feeds on the bait for one night only. Amounts providing a lethal dose after a longer period of feeding, however are also within the scope of the invention. Suitable amounts of brodifacoum, difethialone, flocoumafen and bromadiolone or mixtures thereof are from 10 to 250 ppm, preferably 20 to 100 ppm, more preferably 25 to 50 ppm.

Brodifacoum, bromadiolone, difethialone and flocoumafen are insoluble or weakly soluble in water. Manufacturing concentrates of these anticoagulants traditionally contain the active dissolved in an organic solvent, the solvent being selected to be palatable or at least tasteless to rodents. Or they may be available as a powder pre-mix in which some inert powdered ingredient (eg. wheat flour) is used as a diluent. For the composition of the present invention, it is desirable to maintain neutral pH to avoid hydrolysis of fipronil. The likely effect of any solvent or diluent on pH must therefore be considered. The most preferred rodenticide for the bait composition of the present invention is brodifacoum. Usually, brodifacoum, as its triethanolamine salt, has been provided as a solubilised 0.25% or 2.5% concentrate in a solvent (eg. propylene glycol) with a red or blue dye. Preferably, the brodifacoum for the present invention is formulated without triethanolamine and provided as a 0.25% solution.

Rodenticides which are not anticoagulants but which are also suitable for the present invention include bromethalin, flupropadine, norbormide, calciferol and cholecalciferol (vitamin D3).

In a preferred aspect, the present invention provides a rodenticidal bait composition comprising an insecticidally effective amount up to 200 ppm of fipronil; a rodenticidally effective amount of a rodenticide selected from the group consisting of brodifacoum, difethialone, flocoumafen and mixtures thereof; at least one feeding stimulant and optionally at least one attractant.

In a further preferred aspect, the invention provides a rodenticidal bait composition comprising an acaricidally effective amount up to 200 ppm of fipronil, a rodenticidally effective amount of a rodenticide selected from the group consisting of brodifacoum, difethialone, flocoumafen and mixtures thereof; at least one feeding stimulant and optionally at least one attractant.

The bait composition optionally includes one or more insecticidally, acaricidally and rodenticidally compatible excipients and/or adjuvants such as dye, bittering agent, solvent, flow agent, binder, weatherability enhancer and preservative.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Combinations of fipronil with brodifacoum, difethialone and flocoumafen have been found to be highly palatable to Rattus norvegicus (Norway rat) and Mus domesticus (house mouse). It is expected that combinations of fipronil with mixtures of these anticoagulants will also be highly palatable to these rodents. It is expected that the combinations will also be palatable to other rodents such as Arvicola terrestris, Microtus arvalis, Microtus pennsylvanicus, Tatera indica, Peromyscus leucopus, Peromyscus maniculatus, Mastomys natalensis, Rattus rattus, Rattus argentiventer, Rattus exulans, Sigmodon hispidus, Arvicanthis niloticus, Bandicota bengalensis, Bandicota indica, Nesokia indica, Meriones hurrianae, Millardia meltada and all members of the Mus genera as these rodents are also feeders on grain-based materials/baits. Suitable amounts of fipronil and rodenticide are as discussed above.

### Attractants/Feeding Stimulants

The bait composition of the present invention includes at least one feeding stimulant and optionally at least one attractant. An attractant is a material that is used to help bring a rodent close to the bait. A feeding stimulant entices the rodent to feed and to keep feeding on the bait. A material may function as both an attractant and a feeding stimulant. Attractants can be a food item or a ‘curiosity enhancer’. The former motivates the rodent to approach the bait out of desire to eat it while the latter motivates a rodent to approach out of some other, non-food related desire (eg. to investigate where an interesting odour is coming from). Pheromones (eg. sexual attractants) are examples of curiosity enhancers. Attractants rely on odour solely to bring the rodent into close proximity to the bait thereby increasing the chance that the rodent will eat the bait. Examples of attractants and feeding stimulants that are suitable for the composition of the present invention are given in Table 2 below.

TABLE 2

| | | Feeding |
|---|---|---|
| Material | Attractant? | Stimulant? |
| seeds, cereal grains | Yes | Yes |
| Sugar and sugar products (eg. | Yes | Yes |
| granulated sugar, confectioner's | | |
| sugar at 1-5%) | | |
| Pheromones | Yes | No |
| Corn starch/corn meal | Yes | Yes |
| Salt | No | Yes |
| Monosodium glutamate | No | Yes |
| Vegetable oils (eg. one or more | Yes | Yes |
| of peanut, coconut, sesame, | | |
| sunflower, linseed, palm, | | |
| rapeseed, olive, corn and | | |
| soyabean) | | |

Oils are also used as ‘stickers’ in seed/grain bait, binding the poison mix to the outside of the bait.

Suitable stimulants, which are also attractants include: whole and processed seeds including cereal grains; sugar and sugar products; honey; meat and meat products including blood and fat; dairy products; eggs and egg products including shell and yolk; starch; whole and processed nuts; and vegetable oils. The term “seeds” is intended to include seeds in general such as sunflower, thistle, poppy and pumpkin seeds as well as cereal grains such as oats, wheat, rice, barley, corn and millet. The term “processed seeds” is intended to include seeds that are crushed, cracked, rolled, or milled to various consistencies including flour. Suitable vegetable oils include peanut, coconut, sesame, sunflower, linseed, palm, rapeseed, olive, corn, soybean and blends of two or more thereof.

The bait composition of the present invention may include a mixture of feeding stimulants. It may also include at least one attractant. Suitable attractants include pheromones, yeast, and black pepper.

Preferred attractants/stimulants are whole and processed seeds including cereal grains; sugar and sugar products; starch; nuts and processed nuts; and vegetable oil.

Suitably, the total amount of attractants/stimulants in the bait composition as a percentage by weight will range from 50-99.999%.

### Optional Excipients and Adjuvants

The bait composition may also comprise one or more optional components such as dye, bittering agent, flow agent, binder, weatherability enhancer and preservative.

Dyes are often added to bait to clearly identify them as non-food items, to deter accidental consumption by people, to deter consumption by non-target animals and to disclose consumption of the bait in the faeces or vomitus. The most common colours used are deep greens and blues.

Bittering agents may be included to minimise the risk of accidental consumption by humans. A suitable agent is denatonium benzoate. This is an extremely bitter tasting compound that at the optimum concentration will be highly distasteful to people but not to rodents. When present, a human taste deterrent is suitably used in an amount of from 1 to 200 ppm, preferably from 1 to 100 ppm, more preferably from 5 to 50 ppm and most preferably from 5 to 20 ppm.

Flow agents and binders may be included depending on the format of the bait composition. Binders (eg. corn oil) are used to stick the poison to the outside of loose whole grains and seeds or to help provide some cohesion to the bait if prepared in the form of a paste. Flow agents (eg. mineral clay, aluminium silicate) facilitate extrusion and are therefore often used in pellets and extruded blocks. Various bait formats are discussed below.

The addition of paraffin wax to bait greatly improves its resistance to moisture and hence its weatherability. Paraffin greatly improves the effectiveness of rodenticidal baits in tropical, humid climates; in damp indoor locations (kitchens, garages etc.); and in a number of different outdoor situations (eg. sewer and burrow baiting). Suitable amounts of paraffin range from 5-50%.

Other insecticides (eg. 0.1% Malathion) and mould inhibitors (eg. 0.1% 2, 3, 5 trichlorophenylacetate) may be added to grain-based bait to prevent attack by insect pests and to extend the shelf life of the product. Antioxidants may be included to preserve oils and animal products. Antioxidants that may be included are TBHQ, butylated hydroxytoluene or butylated hydroxyanisole. These may be present in amounts of 10 ppm to 20,000 ppm (more ideally 0.05-1%). Amongst the preservatives that may be used are sorbic acid and salts thereof (e.g. potassium sorbate), Dowicil™ (Dow-Elanco) and methyl- and propylparabens. Suitably, preservatives may be present in an amount from 0.01-1% more preferably 0.05-0.5%.

### Bait Formats

There are a wide variety of conventional bait formats suitable for the present invention. The choice of format will depend on the environment in which it is to be used. No format is ideal for all situations and problems. Table 3 below lists some conventional formats and summarises the advantages and disadvantages of each.

### Meal

Meal baits consist of a mixture of whole, ground and/or rolled grains in a range of sizes from fine powdery particles (flour, corn meal) to whole rolled oats, or whole or broken grains.

Rodents commonly carry food back to their nest or borrow where they may eat it, store it and eat it at a later time, or store it and never eat it. For poisoned bait, the latter is clearly wastage. Meal minimises hoarding simply because it is difficult for a rodent to carry away. The main disadvantages of meal is that it can be messy to use (flour is hard to clean up and can be inhaled), it can be easily contaminated with dirt reducing its desirability to rodents, and its quality quickly deteriorates once removed from its packaging.

| Format | Advantage | Disadvantage |
|---|---|---|
| Meal | Highly palatable. | Dust can be easily |
| | Easily digested (small | spread (clean-up is more |
| | particle size). | difficult). |
| | Hard to hoard (cannot be | Dust can be inhaled by |
| | easily carried away). | user. |
| | Economical. | Short life-span: |
| | | affected by moisture |
| | | (very poor |
| | | weatherability). |
| | | Palatability may be an |
| | | issue if the active is |
| | | intrinsically |
| | | unpalatable (poison is |
| | | on surface). |
| | | Easily contaminated with |
| | | dirt which may reduce |
| | | palatability. |
| Seed/grain | Highly palatable. | Attractive to non- |
| (whole | Grains can be very | target, granivorous |
| or cut) | economical. | (grain/seed eating) |
| | | birds and mammals. |
| | | Potential poisoning risk |
| | | to people (children or |
| | | hungry adults). |
| | | Palatability may be an |
| | | issue if the active is |
| | | intrinsically |
| | | unpalatable (poison is |
| | | concentrated on the |
| | | surface of the |
| | | seeds/grain and can be |
| | | wiped off). |
| | | Poor weatherability. |
| | | Some seeds may be |
| | | expensive. |
| | | Can be easily hoarded. |
| Pellet | More palatable than | Can be hoarded. |
| | waxed products. | Poor weatherability. |
| | Hard with edges: | Small enough to be taken |
| | attractive for rodents | by granivorous birds. |
| | to gnaw on. | |
| | Less attractive to non- | |
| | target animals | |
| | (including humans). | |
| | Low spillage rates - | |
| | easier clean up. | |
| Waxed | Moisture resistant. Good | Probably less palatable |
| pellet | for humid climates or | than normal pellets. |
| | the wetter parts of | Small enough to be taken |
| | homes (laundry or | by granivorous birds. |
| | garage). | Can be hoarded. |
| | Edges for gnawing. | |
| | Low attractiveness to | |
| | non-target animals | |
| | (including people). | |
| | Low spillage rates - | |
| | easier clean up. | |
| Moulded | Moisture and rain | Low palatability due to |
| wax | resistant. Can be used | high wax content. |
| block | outdoors. | High temperature |
| | Multiple gnawing edges. | manufacture: some |
| | Less attractive to non- | flavour and freshness is |
| | target animals | lost and so palatability |
| | (including people). | is reduced. |
| | Very low spillage - easy | Can melt and soften at |
| | clean up. | high temperatures: |
| | Smooth, shiny surface is | palatability is reduced. |
| | attractive to users. | Smooth, shiny surface is |
| | Can be secured to | less attractive to |
| | substrate (nailed or | rodents. |
| | tied). | |
| Compressed | Moisture resistant. | Low palatability but |
| or | Very low spillage - easy | probably higher than |
| Extruded | clean up. | moulded blocks |
| wax | Low attractiveness to | Not as water resistant |
| block | non-target animals | outdoors as are moulded |
| | (including people). | blocks because less wax |
| | Lower temperatures | is used. Compressed |
| | during manufacturing | block probably has lower |
| | than wax blocks: better | weatherability than |
| | palatability. | extruded block. |
| | Rougher surface and more | |
| | gnawing edges than | |
| | moulded blocks. | |
| | Lower wax content than | |
| | moulded blocks: better | |
| | palatability. | |
| | Melting at high | |
| | temperatures is less of | |
| | a problem. | |
| | Can be secured to | |
| | substrate (nailed or | |
| | tied). | |

### Seeds/Cereal Grains

Seed mixes such as canary seed, and whole, cracked or rolled cereal grains such as wheat, rice, maize, oat, barley and millet form the basis of most commercial baits. For whole grain baits, husks or hulls are removed. The poison is stuck to the outside of the seed or grain using a ‘sticker’ substance while the inside of the grain or seed may remain free of poison.

Seeds in general and cereal grains in particular are a highly desirable food for commensal rodents. The type of seed or grain preferred depends on the type of rodent and on the type of seed or grain with which they are familiar (rice, wheat, millet etc). The size of the grain or seed should be within preferred range for the target rodent. For example, Norway rats prefer grains in the 0.4 to 0.7 mm diameter size range. Rats generally prefer bigger grains and seeds than mice.

The main disadvantage of whole seed or grain bait is that it is easy for a rodent to hoard and it can be very attractive to nontarget animals such as granivorous (seed or grain eating) birds. Also, this format could have palatability problems if the poison is intrinsically unpalatable. The poison is stuck to the outside of the grain or seed so is at a relatively high concentration. When a rodent bites into the bait it is much more likely to taste a poison than would be the case for more homogenous bait formats such as pellets and blocks. A similar difficulty may apply to meal baits.

### Pellets

Pellets are produced by extruding a steamed, soft, hot dough mix of milled grain, poison and other additives through a die after which they are then cut to size.

Pellets are hardened by compression during the process of extrusion and, after extrusion, as they set and moisture content is lowered during oven drying. The degree of hardening is a function of temperature, compression pressure used and drying time. The result is hard, brittle pellets of a consistent diameter and length. Size may vary depending on the target rodent (rat or mouse). Pellets are usually about 3-5 mm diameter and 5-10 mm long cylinders. The addition of an amount of paraffin wax improves the moisture-resistance capabilities (ie. weatherability) of the pellets. However, while this extends their range of applications to, for example, more humid areas of the house and gives the pellets better performance in humid climates, it also probably lowers the palatability of the bait. Pelletised bait is the most widespread and common rodenticide format and appears to be good general-purpose bait.

### Moulded Wax Blocks

Moulded blocks are made by pouring a hot blend of grain, melted wax (typically 25-40%), poison and other additives into a mould to produce, upon cooling, a smooth, shiny, solid but waxy product. Blocks of 3-5 g and 15-35 g are typically produced.

Of the bait formats this is the most moisture resistant but also the least palatable to rodents (the general rule is that the higher the wax content the less palatable the bait). Furthermore, the high temperature used during manufacture cooks and reduces the freshness and palatability of grains in the bait. Exposure to high temperatures (eg. hot climates, or when put in roof voids) can cause the wax to soften. This makes the bait unpalatable to rats and mice and so ineffective. The smoothness and shiny appearance of these blocks can make them less attractive to rodents.

Blocks may be made with a hole through the centre. This allows the blocks to be nailed to a substrate or secured in bait stations to prevent rodents carrying the bait away. Holes allow the blocks to be suspended off the ground (eg. nailed to roof rafters in black rat control, or to minimise exposure to water) or threaded onto metal wire for insertion into burrows or down drains (Norway rat control).

### Extruded Blocks or Cake

The palatability problem with moulded blocks is ameliorated with extruded blocks in two ways: less wax is used and the manufacturing temperature is lower. Though less wax is used, extruded blocks still have excellent moisture resistance characteristics. They are produced using a process similar to that used to manufacture bait pellets—extrusion and compression of dough through a die with subsequent cutting to size. Compared to moulded blocks, extruded blocks are harder, have a duller, relatively rougher surface; all three features increasing the attractiveness of these blocks to rodents. Some are designed to be broken into smaller pieces by the user whereas others are cut to a size as they exit the die.

The manufacturing process allows these products to be made into complex shapes with multiple sharp edges to encourage rodents to gnaw the bait. The idea is that rodents like to chew on corners because this gives purchase for their teeth. Dies are therefore used that aim to maximise the number of corners while optimising their arrangement on the block. The effectiveness of blocks with many corners versus those with few is unknown. As for moulded blocks, extruded blocks may be made with hole for attachment. The lower wax content also makes them less prone to softening at high temperatures.

### Compressed Blocks

Like extruded blocks, the compressed block format also aims to optimise the balance between palatability and weatherability. They are not made by extrusion through a die but by compression of a warm dough mix in a mould that shapes and compresses it to ensure a hard block upon cooling and drying. Compressed blocks have a dull finish but are smoother than extruded blocks. They also have a dusty surface (perhaps to facilitate their release from the mould).

### Paste

This is a soft mix of meal bait based on fats or oils. This format thus has a high moisture content differentiating it from all other formats. It can be a very useful format to use in locations where spillage of bait can be a problem (eg. food storage areas, kitchens etc.) or where rodents have limited access to water. Pastes and gels may be applied with caulking guns.

### Comparison of Formats

As mentioned above, each format is generally designed for different rodent control situations and problems. Table 4 compares format on a number of key performance measures.

TABLE 4
Comparison formats on key performance measures.

| Feature | Best format | Worst format |
|---|---|---|
| Palatability | Meal or whole seed | Moulded wax block |
| | and grain | |
| Moisture | Moulded wax block | Meal |
| resistance | | |
| Resistance | Meal and block | Whole seed and |
| to hoarding | products | grain |
| Spillage | Block products | Meal |
| minimisation | | |
| Economy | Whole grain | Block |
| | | products/pellets |

### MODES FOR CARRYING OUT THE INVENTION

The invention will now be further illustrated with reference to the following non-limiting examples:

### EXAMPLES

### Pelletised Bait Compositions

The following example bait formulations use 0.25% w/w or 2.5% w/w brodifacoum liquid concentrates to make a bait with a nominal brodifacoum concentration of 50 ppm (0.005% w/w).

Suitable liquid and solid concentrates of other rodenticides (e.g. difethialone at 0.12% w/w liquid concentrate or 0.5% w/w dry concentrate; or flocoumafen at 0.5% dry concentrate) can also be substituted into the formulations. Difethialone is typically formulated as a 25 ppm bait while actives such as flocoumafen and bromadiolone are formulated as 50 ppm baits. If a different active or a concentrate of a particular active is to be used then the baits are made up to 100% by weight by adjusting the percentage of wheat flour added to the formulations.

| | | |
|---|---|---|
| Component | Wt % | Function |

Example 1

| | | |
|---|---|---|
| Wheat flour | 82.892 | Food |
| | | attractant/stimulant |
| Millet | 10.000 | Food |
| | | attractant/stimulant |
| Confectioner's | 3.500 | Feeding stimulant |
| sugar | | |
| Corn meal | 1.500 | Food |
| | | attractant/stimulant |
| Brodifacoum 0.25% | 2.000 | Rodenticide |
| concentrate | | Active |
| Green dye | 0.100 | Colour |
| Denatonium | 0.004 | Bittering agent |
| benzoate (25% | | |
| solution) | | |
| Fipronil | 0.004 | Insecticide/acaricide |

Example 2

| | | |
|---|---|---|
| Wheat flour | 88.892 | Food |
| | | attractant/stimulant |
| Sugar | 5.000 | Feeding stimulant |
| Corn meal | 4.000 | Food |
| | | attractant/stimulant |
| Brodifacoum 0.25% | 2.000 | Rodenticide Active |
| concentrate | | |
| Green dye | 0.100 | Colour |
| Denatonium | 0.004 | Bittering agent |
| benzoate (25% | | |
| solution) | | |
| Fipronil | 0.004 | Insecticide/acaricide |

Example 3

| | | |
|---|---|---|
| Wheat flour | 85.392 | Food |
| | | attractant/stimulant |
| Corn starch | 0.500 | Food |
| | | attractant/stimulant |
| Millet | 10.000 | Food |
| | | attractant/stimulant |
| Confectioner's | 2.000 | Feeding stimulant |
| sugar | | |
| Brodifacoum 0.25% | 2.000 | Rodenticide Active |
| concentrate | | |
| Green dye | 0.100 | Colour |
| Denatonium | 0.004 | Bittering agent |
| benzoate (25% | | |
| solution) | | |
| Fipronil | 0.004 | Insecticide/acaricide |

Example 4

| | | |
|---|---|---|
| Wheat flour | 84.392 | Food |
| | | attractant/stimulant |
| Millet | 5.000 | Food |
| | | attractant/stimulant |
| Sugar | 4.000 | Feeding stimulant |
| Peanut meal | 2.500 | Food |
| | | attractant/stimulant |
| Corn oil | 2.000 | Food |
| | | attractant/stimulant |
| | | Food |
| | | attractant/stimulant |
| Brodifacoum 0.25% | 2.000 | Rodenticide Active |
| concentrate | | |
| Green dye | 0.100 | Colour |
| Denatonium | 0.004 | Bittering agent |
| benzoate (25% | | |
| solution) | | |
| Fipronil | 0.004 | Insecticide/acaricide |

Example 5

| | | |
|---|---|---|
| Wheat flour | 87.192 | Food |
| | | attractant/stimulant |
| Rolled oats | 5.000 | Food |
| | | attractant/stimulant |
| Corn meal | 5.000 | Food |
| | | attractant/stimulant |
| Confectioner's | 2.500 | Feeding stimulant |
| sugar | | |
| Brodifacoum 2.5% | 0.200 | Rodenticide active |
| concentrate | | |
| Green dye | 0.100 | Colour |
| Denatonium | 0.004 | Bittering agent |
| benzoate (25% | | |
| solution) | | |
| Fipronil | 0.004 | Insecticide/acaricide |

Example 6

| | | |
|---|---|---|
| Wheat flour | 78.692 | Food |
| | | attractant/stimulant |
| Corn Meal | 5.000 | Food |
| | | attractant/stimulant |
| Millet | 10.000 | Food |
| | | attractant/stimulant |
| Confectioner's | 4.000 | Feeding stimulant |
| sugar | | |
| Peanut Meal | 2.000 | Food |
| | | attractant/stimulant |
| Brodifacoum 2.5% | 0.200 | Rodenticide active |
| concentrate | | |
| Green dye | 0.100 | Colour |
| Denatonium | 0.004 | Bittering agent |
| benzoate (25% | | |
| solution) | | |
| Fipronil | 0.004 | Insecticide/acaricide |

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

### Method of Preparation

The formulations given above was prepared as follows:

Fipronil was weighed into a flask.

The liquid ingredients were weighed into the flask containing the fipronil. These ingredients were then stirred vigorously for 2 hours on magnetic stirrer or until the fipronil was completely dissolved.

The remaining dry ingredients were pre-weighed and added to the a powder mixing vessel (Forberg Paddle mixer—20 L capacity).

The mixer was switched on and the contents allowed to mix until well blended (approximately 5 minutes).

The liquid ingredients were transferred to a dispensing device. This device was specially designed to spray liquid under pressure into the powder mixing vessel.

After the dry ingredients had mixed for approximately 5 minutes, the liquid ingredients were sprayed into the mixture. The liquid and dry ingredients were allowed to mix for an additional 5 minutes.

The mixed material (mash) was removed from the powder mixer and poured into the pelletising feed hopper. The pelletiser used was CPM Laboratory Pellet Mill Serial No. 386003

The mash passes from the feed hopper via a screw conveyer to the conditioner. In this chamber the mash is tumbled in the presence of steam increasing the temperature of the mash to 70-90° C.

From the conditioner the mash enters the pelletiser where it is compressed between a pressure roller and a rotating die. Continuous rods of compressed mash are extruded from the die to be cut to length by a knife to form the pellets.

The pellets then passed down a chute out of the pelletiser where they are collected and spread onto trays to cool and dry at ambient air temperature for at least 60 minutes.

The cooled dried pellets were then roughly screened to remove undersized pellets.

Samples of pellets were taken for laboratory analysis.

### Efficacy Results

The following nonlimiting examples provide further demonstration of the utility of the present invention. The bait formulation used in Examples 7-13 was nominally 50 ppm brodifacoum and 40 ppm fipronil. Different studies did not necessarily use the same batch of material. Example 14 involved the use of 50 ppm flocoumafen and 40 ppm fipronil bait and Example 15 involved the use of 25 ppm difethialone and 40 ppm fipronil bait.

### Example 7

This study aimed to determine if the invention could kill 90% or more of laboratory strains of Norway rat (Rattus norvegicus) (Sprague-Dawley strain) and house mice (Mus domesticus) (Swiss-Webster strain) in a single nights exposure. These tests, conduct in June 2003, followed the United States Environmental Protection Agency Office of Pesticide Program Protocols 1.209 (rat) and 1.210 (mouse) modified for a 1-day exposure period. These are choice-feeding trials in which the test animals were simultaneously exposed to the test bait and a non-poisonous but palatable challenge diet. The treatment groups consisted of 20 rats and 20 mice in a 1:1 sex ratio. A control group of 10 rats or 10 mice (also at a 1:1 sex ratio) were also included. The control animals were only exposed to the challenge diet. Following acclimatisation, treatment animals were exposed to the test bait for 24 hours. After 24 h, the test bait was removed and the animals were henceforth fed only on the challenge diet. The animals were monitored daily until any sick animals had either died or recovered. The time of death was recorded for any animal that succumbed during the monitoring period.

No mortality was recorded in any of the control rats or mice. Mortality for rats was 95% with a mean time to death of 7.2 days. Mortality for mice was also 95% with a mean time to death of 6.6 days. Mortality of both rats and mice following a single day exposure to the test bait was ≧90% demonstrating that the invention kills laboratory strains of Norway rats and house mice in a single night's feeding.

### Example 8

This study determined the efficacy of the invention against nymphal stage ticks Ixodes trichosuri on laboratory Norway rats (Wistar Strain). Conducted during June 2003, the trial was a replicated choice-feeding study in which rats had a choice of the invention and a challenge diet over a 3-day exposure period. Nymphal ticks were attached to the rats in a retainer on the shaved neck of the rats 1 day prior to exposure to the bait. The retainers were designed to ensure easy monitoring of ticks with minimal disturbance to both the rats and the ticks.

Ticks typically attached within a few hours of introduction onto the rats. The attachment site of each tick was recorded allowing the progress of individual ticks to be monitored. The study consisted of two replicates of 5 male and 5 female rats to each of which a maximum of 8 ticks was attached. Each replicate had a control group of 5 male and 5 female rats to which a maximum of 8 ticks were also attached. The control animals were not exposed to the invention and were fed only on the challenge diet during the monitoring period. The rats and their ticks were monitored daily until any sick rats had either died or recovered. Rats that had become moribund clearly from the effects of the anticoagulant poison were humanely euthanased. The time of death was recorded for each rat and the size and status (alive, dead, moribund) of each ticks was also recorded daily. Any dead ticks were removed and new ticks added when the total number on the rat was 4 or less.

No mortality was recorded for any of the control rats. Tick mortality on control rats was <5% with ticks needing 4-7 days to engorge and voluntarily detach. The average time to death of the treatment rats was 6.4 days. (This is a slight underestimation of the actual time to death because 65% of the rats were euthanased because they had become terminally moribund. The actual time to death would likely be between 7.0-7.5 days) All the initial cohort of ticks placed on the treatment rats failed to engorge and died within 7 days of exposure to the invention. By the time rats started to die from the effects of brodifacoum (3 days from the first exposure), survival of the initial cohort of ticks was only 41% and was <5% by the fifth day following first exposure. The death rate for the ticks was therefore faster than that of the rats. Additional ticks added to surviving rats all failed to engorge and died within 2-3 days of attachment. There was no evidence that ticks failed to attach to treated rats indicating that treatment with the invention did not make the rats repellent to the ticks. These results demonstrate that the invention is effective at killing Norway rats, at killing ticks that infested rats prior to exposure to invention, and at killing ticks that attached to the treated rats after exposure to invention.

### Example 9

The efficacy of the invention against nymphal paralysis tick Ixodes holocyclus on the house mouse (Swiss outbred Strain) was determined in October 2003 using a methodology similar to that described in Example 8. This study, too, was a choice-feeding trial over a 3-day exposure period using ticks held in a retainer on the shaved neck of the mice. Ticks were place on the mice prior to exposure to the test bait, and fresh ticks introduced as the ticks on the mice died. A single replicate of 5 male and 5 female mice in each of the treatment and control groups was used. A total of 8 ticks were attached to each treatment and control mouse. Additional ticks were added to a mouse whenever the numbers of surviving tick was ≦4 such that the total number of ticks on the mice at any time did not exceed 8.

Mortality for the control mice reached 100% with the symptoms displayed suggesting that the cause of death was the toxins produced by the ticks. Tick mortality on control mice was <5% with ticks engorging in 4-6 days. All treatment mice also died but in this case the symptoms displayed indicate the cause of death being due to anticoagulant toxicosis. The average time to death of the treated mice was longer than for the control mice (6.0 vs 4.8 days). All treated mice had died or had become terminally moribund by 7 days after first exposure to the invention. In contrast to the high survival rate of ticks in the control group, 95% of the initial cohort of ticks placed on the treatment mice died within 6 days of first exposure to the invention, and all failed to engorge. The death rate of the ticks exceeded that for the mice. Most ticks added to surviving mice after bait exposure died within 3 days of attachment. Only those attaching within 1-2 days of the time of death of the mice managed to survive the death of the host. These results indicate that the invention kills >90% of mice, kills >90% of the ticks placed on mice prior to exposure to the invention before the mice died from the effects of the rodenticide and kills >90% ticks that are attached to mice after exposure to the invention if attachment occurs before 1-2 days of the death of the mouse.

### Example 10

The efficacy of the invention against cat fleas (Ctenocephalides felis) on Norway rats (Wistar Strain) was determined in a choice-feeding trial over a 3-day exposure period. Adult fleas (10 per rat) were held in a retainer on the shaved neck of the rats. Fleas were placed on the rats prior to exposure to the test bait, and fresh fleas introduced when the number of fleas surviving on the rats was ≦6. The maximum number of fleas on a rat at any time did not exceed 10. The study was conducted in two replicated trials in June 2003. Each replicate consisted of a treatment group of 5 male and 5 female rats, and a control group of 5 male and 5 female rats. Both control and treatment animals were infested with fleas. However, treatment animals were exposed to the invention and an alternative challenge diet whereas the control group was only given the challenge diet.

No mortality was recorded among the control rats and the mortality of fleas on the control rats was <10%. All treatment rats died or had become terminally moribund within 5-7 days after first exposure to the invention. Mortality of the initial cohort of fleas was >90% within 3 days of first exposure invention. Mortality of the subsequent cohorts of fleas was >90% within a single day of their introduction and attachment to the rats. This effect continues until the death of the rat. These results show that the invention was highly effective at killing rats and the fleas placed on them prior to exposure to the invention. The invention was also very effective at killing any fleas placed on, and attaching to rats after exposure to the bait had ceased.

### Example 11

This study used the same methodology as that described in Example 10 to determine the efficacy of the invention against the stickfast flea (Echidnophaga gallinacea) on Norway rats (Wistar Strain). The two replicates of this study were conducted in June 2003.

No mortality was recorded among the control rats and the mortality of their fleas was <10% during the period of the study. All treatment rats died or had become terminally moribund within 4-10 days of first exposure to the invention. Mortality of the initial cohort of fleas was 100% within 3 days of first exposure to the invention. Mortality of the subsequent fleas was >95% within a day of their introduction and attachment to the rats. This effect continued until the death of the rat. These results show that the invention was highly effective at killing rats and the fleas placed on them prior to exposure to the invention. The invention was also very effective at killing any fleas placed on, and attaching to rats after exposure to the bait had ceased.

### Example 12

The efficacy of the invention against the cat flea (Ctenocephalides felis) on house mice (Swiss outbred Strain) was determined in July 2003 using the same methodology as that described in Example 10.

Three control mice (15%) died during the study, most likely due to the stress or injury during handling. Flea mortality on the control mice was <5%. All treatment mice died or had become terminally moribund within 5-9 days of first exposure to the invention. Mortality of the fleas placed on the mice prior to exposure to the invention was 100% within 2 days of first exposure. All fleas added thereafter died within a day of their introduction and attachment. This effect continued until the death of the rat. These results show that the invention was highly effective at killing mice and the fleas placed on them prior to exposure to the invention. The invention was also very effective at killing any fleas placed on, and attaching to mice after exposure to the bait had ceased.

### Example 13

The efficacy of the invention against the stickfast flea (Echidnophaga gallinacea) on house mice (Swiss outbred. Strain) was determined in June 2003 using the same methodology as that described in Example 12.

No control mice died during the study. Flea mortality on the control mice was <5%. All treatment mice died or had become terminally moribund within 4-9 days of first exposure to the invention. Mortality of the fleas placed on the mice prior to exposure to the invention was 100% within 2 days of first exposure. More than 95% of fleas added thereafter died within a day of their introduction and attachment. This effect continued until the death of the rat. These results show that the invention was highly effective at killing mice and the fleas placed on them prior to exposure to the invention. The invention was also very effective at killing any fleas placed on, and attaching to mice after exposure to the bait had ceased.

### Example 14

This study aimed to determine if, following a 4-night exposure period to a 50 ppm flocoumafen plus 40 ppm fipronil version of the bait, the invention could:

kill 90% or more of laboratory strains of Norway rat (Rattus norvegicus) (Sprague-Dawley strain) and house mice (Mus domesticus) (Swiss-Webster strain); and
achieve a palatability ratio of ≧33% or more (ie. ≧33% of the food eaten was the invention).

It was assumed that if the flocoumafen plus fipronil version of the bait had a sufficient palatability (ie. ≧33%) to kill the rodents then the amount of fipronil ingested would also be as lethal to fleas and ticks as was the brodifacoum plus fipronil version used in Examples 8-13.

The tests, conduct in October 2004, followed the United States Environmental Protection Agency Office of Pesticide Program Protocols 1.203 (rat) and 1.204 (mouse) modified for a 4-day exposure period. These are choice-feeding trials in which the test animals were simultaneously exposed to the test bait and a non-poisonous but palatable challenge diet. The treatment groups consisted of 10 rats or 10 mice, each in a 1:1 sex ratio. A control group of 10 rats or 10 mice (also at a 1:1 sex ratio) were also included. The control animals were only exposed to the challenge diet. Following acclimatisation, treatment animals were exposed to the test bait for 4 days after which the test bait was removed and the animals were only fed the challenge diet. The animals were monitored daily until any sick animals had either died or recovered. The time of death was recorded for any animal that succumbed during the monitoring period.

No mortality was recorded in any of the control rats or mice. Mortality for rats and mice was 100%. Average palatability over 4 days of exposure to the invention was 50.6% rats and 62.6% for mice. Thus, mortality of both rats and mice to the test bait was ≧90% and palatability was ≧33%.

### Example 15

This study aimed to determine if, following a 4-night exposure period to a 25 ppm difethialone plus 40 ppm fipronil version of the bait, the invention could:

kill 90% or more of laboratory strains of Norway rat (Rattus norvegicus) (Sprague-Dawley strain) and house mice (Mus domesticus) (Swiss-Webster strain); and
achieve a palatability ratio of ≧33% or more (ie. ≧33% of the food eaten was the invention).

It was assumed that if the difethialone plus fipronil version of the bait had a sufficient palatability (ie. ≧33%) to kill the rodents then the amount of fipronil ingested would also be as lethal to fleas and ticks as was the brodifacoum plus fipronil version used in Examples 8-13.

The tests, conduct in October 2004, followed the United States Environmental Protection Agency Office of Pesticide Program Protocols 1.203 (rat) and 1.204 (mouse) modified for a 4-day exposure period. These are choice-feeding trials in which the test animals were simultaneously exposed to the test bait and a non-poisonous but palatable challenge diet. The treatment groups consisted of 10 rats or 10 mice, each in a 1:1 sex ratio. A control group of 10 rats or 10 mice (also at a 1:1 sex ratio) were also included. The control animals were only exposed to the challenge diet. Following acclimatisation, treatment animals were exposed to the test bait for 4 days after which the test bait was removed and the animals were only fed the challenge diet. The animals were monitored daily until any sick animals had either died or recovered. The time of death was recorded for any animal that succumbed during the monitoring period.

No mortality was recorded in any of the control rats or mice. Mortality for rats and mice was 100%. Average palatability over 4 days of exposure to the invention was 64.5% rats and 75.9% for mice. Thus, mortality of both rats and mice to the test bait was ≧90% and palatability was ≧33%.

### CONCLUSIONS

The results of the series of studies conducted show that the invention:

Is effective at killing rats and mice,
Will kill >90% of rats and mice following one nights exposure,
Kills >90% of the ticks that were infesting rats and mice prior to exposure to the invention.
Kills >90% of the ticks that were infesting rats and mice prior to exposure to the invention before the rats or mice die from the effects of the rodenticide.
Kills >90% of ticks that are placed on rats and mice after exposure to the invention ceases, so long as attachment occurs within 1-2 days of the death of the rodent.
Kills >90% of the fleas that were infesting rats and mice prior to exposure to the invention.
Kills >90% of the fleas that were infesting rats and mice prior to exposure to the invention placed before the rodents die from the effects of the rodenticide.
Kills >90% of fleas that are that are placed on rats and mice after exposure to the invention. This effect continues until the death of the rodent.

### Additional Conclusions

A 50 ppm flocoumafen plus 40 ppm fipronil version of the invention was 100% lethal and highly palatable to rats and mice following a 4-day exposure. This version of the invention is thus expected to be as lethal to fleas or ticks infesting the rodents as was the brodifacoum plus fipronil version.

A 25 ppm difethialone plus 40 ppm fipronil version of the invention was 100% lethal and highly palatable to rats and mice following a 4-day exposure. This version of the invention is thus expected to be as lethal to fleas or ticks infesting the rodents as was the brodifacoum plus fipronil version.

### INDUSTRIAL APPLICABILITY

The compositions of the present invention may be used to control rodents known to feed on grain-based baits such as Rattus norvegicus, Rattus rattus, Rattus argentiventer, Rattus exulans, Mus sp. Arvicola terrestris, Microtus arvalis, Microtus pennsylvanicus, Tatera indica, Peromyscus leucopus, Peromyscus maniculatus, Mastomys natalensis, Sigmodon hispidus, Arvicanthis niloticus, Bandicota bengalensis, Bandicota indica, Nesokia indica, Meriones hurrinanae, and Millardia meltada and their ectoparasites such as fleas of the type Ctenocephalides felis, Ctenocephalides canis, Xenopsylla cheopis, Xenopsylla astia, Xenopsylla brasiliensis, Echidnophaga sp., Pulex irritans, Nosopsyllus fasciatus; and ticks of the type Dermacentor variabilis, Dermacentor andersoni, Dermacentor reticulatus, Ixodes pacificus, Ixodes holocyclus, Ixodes ricinus, Ixodes persulcatus, Ixodes spinipalpis, Ixodes scapularis, Ixodes hexagonus, Amblyomma americanum, Rhipicephalus sanguineus, Rhipicephalus simus, Haemaphysalis leporispalustris, Haemaphysalis leachi and Ornithodoros sp.

By killing the parasitic arthropods, successful transfer to a new host following death of a former host is avoided. The risk of infestation of humans and domestic animals is thereby reduced. This may assist in reducing the incidence or risk of contact with the causative agents of such vector-borne diseases as Lyme disease, plague, Rocky Mountain spotted fever, Colorado tick fever, Kyansanur Forest disease, Kerneroyo, Powassan encephalitis, Russian spring-summer encephalitis, Crimean-Congo haemorrhagic fever, tick-borne encephalitis, Mediterranean spotted fever, boutonneuse fever, Q fever, North Asian tick typhus, Queensland tick typhus, murine typhus, tick-bite fever, tularaemia, relapsing fever, ehrlichiosis and babesiosis.

1.-63. (canceled)

64. A rodenticidal bait composition comprising:
an insecticidally effective amount up to 200 ppm of fipronil;
an effective amount of a rodenticide selected from the group consisting of brodifacoum, difethialone, flocoumafen and mixtures thereof; and
at least one feeding stimulant.

65. A composition according to claim 64 comprising, by weight:
at least 0.0001% fipronil;
from 0.001 to 0.025% rodenticide; and
from 50 to 99.999% of at least one feeding stimulant.

66. A composition according to claim 65 comprising at least 0.0002% by weight fipronil.

67. A composition according to claim 65 comprising from 0.002 to 0.010% by weight rodenticide.

68. A composition according to claim 67 comprising from 0.0025 to 0.0050% by weight rodenticide.

69. A composition according to claim 65 wherein the rodenticide is selected from the group consisting of brodifacoum and difethialone.

70. A composition according to claim 69 wherein the rodenticide is brodifacoum and the composition comprises about 0.0050% by weight brodifacoum.

71. A composition according to claim 69 wherein the rodenticide is difethialone and the composition comprises about 0.0025% by weight difethialone.

72. A composition according to claim 64 wherein the feeding stimulant is one or more items selected from the group consisting of whole and processed seeds including cereal grains, sugar and sugar products, honey, meat and meat products including blood and fat, dairy products, eggs and egg products including shell and yolk, starch, whole and processed nuts, and vegetable oils.

73. A composition according to claim 72 wherein the feeding stimulant is one or more items selected from the group consisting of whole and processed seeds including cereal grains, sugar and sugar products, starch, whole and processed nuts, and vegetable oils.

74. A composition according to claim 64 further comprising at least one attractant.

75. A composition according to claim 64 further comprising one or more insecticidally and rodenticidally compatible excipients and/or adjuvants selected from the group consisting of dye, bittering agent, solvent, flow agent, binder, weatherability enhancer and preservative.

76. A rodenticidal bait composition comprising:
an acaricidally effective amount up to 200 ppm of fipronil;
an effective amount of a rodenticide selected from the group consisting of brodifacoum, difethialone, flocoumafen and mixtures thereof; and
at least one feeding stimulant.

77. A composition according to claim 76 comprising, by weight:
at least 0.001% fipronil;
from 0.001 to 0.025% rodenticide; and
from 50 to 99.998% of at least one feeding stimulant.

78. A composition according to claim 77 comprising at least 0.0015% by weight fipronil.

79. A composition according to claim 78 comprising at least 0.0025% by weight fipronil.

80. A composition according to claim 79 comprising at least 0.0040% by weight fipronil.

81. A composition according to claim 77 comprising from 0.002 to 0.010% by weight rodenticide.

82. A composition according to claim 81 comprising from 0.0025 to 0.0050% by weight rodenticide.

83. A composition according to claim 76 wherein the rodenticide is selected from the group consisting of brodifacoum and difethialone.

84. A composition according to claim 83 wherein the rodenticide is brodifacoum and the composition comprises about 0.0050% by weight brodifacoum.

85. A composition according to claim 83 wherein the rodenticide is difethialone and the composition comprises about 0.0025% by weight difethialone.

86. A composition according to claim 76 wherein the feeding stimulant is one or more items selected from the group consisting of whole and processed seeds including cereal grains, sugar and sugar products, honey, meat and meat products including blood and fat, dairy products, eggs and egg products including shell and yolk, starch, whole and processed nuts, and vegetable oils.

87. A composition according to claim 86 wherein the feeding stimulant is one or more items selected from the group consisting of whole and processed seeds including cereal grains, sugar and sugar products, starch, whole and processed nuts, and vegetable oils.

88. A composition according to claim 76 further comprising at least one attractant.

89. A composition according to claim 76 further comprising one or more insecticidally and rodenticidally compatible excipients and/or adjuvants selected from the group consisting of dye, bittering agent, solvent, flow agent, binder, weatherability enhancer and preservative.

90. A rodenticidal bait composition comprising, by weight,
about 0.004% fipronil,
about 0.005% brodifacoum; and
from 50 to 99.7% of at least one feeding stimulant.

91. A rodenticidal bait composition comprising, by weight,
about 0.004% fipronil,
about 0.0025% difethialone; and
from 50 to 99.7% of at least one feeding stimulant.

92. A method of killing ticks and a host rodent thereof, comprising providing for ingestion to said rodent a bait composition comprising an effective amount of a rodenticide selected from the group consisting of brodifacoum, difethialone, flocoumafen and mixtures thereof, and an acaricidally effective amount up to 200 ppm of fipronil.

93. A method according to claim 92 wherein the bait composition provided for ingestion by said rodent comprises at least 10 ppm fipronil.

94. A method according to claim 93 wherein the bait composition provided for ingestion by said rodent comprises at least 15 ppm fipronil.

95. A method according to claim 94 wherein the bait composition provided for ingestion by said rodent comprises at least 25 ppm fipronil.

96. A method according to claim 95 wherein the bait composition provided for ingestion by said rodent comprises at least 40 ppm fipronil.

97. A method according to claim 92 wherein the bait composition provided for ingestion by said rodent comprises from 10 to 250 ppm rodenticide.

98. A method according to claim 97 wherein the bait composition provided for ingestion by said rodent comprises from 20 to 100 ppm rodenticide.

99. A method according to claim 98 wherein the bait composition provided for ingestion by said rodent comprises from 25 ppm to 50 ppm rodenticide.

100. A method according to claim 92 wherein the bait composition provided for ingestion by said rodent comprises a rodenticide selected from the group consisting of brodifacoum and difethialone.

101. A method according to claim 100 wherein the bait composition provided for ingestion by said rodent comprises brodifacoum in an amount of about 50 ppm.

102. A method according to claim 100 wherein the bait composition provided for ingestion by said rodent comprises difethialone in an amount of about 25 ppm.

103. A method of killing fleas and a host rodent thereof, comprising providing for ingestion to said rodent a bait composition comprising an effective amount of a rodenticide selected from the group consisting of brodifacoum, difethialone, flocoumafen and mixtures thereof, and an insecticidally effective amount up to 200 ppm of fipronil.

104. A method according to claim 103 wherein the bait composition provided for ingestion by said rodent comprises at least 1 ppm fipronil.

105. A method according to claim 104 wherein the bait composition provided for ingestion by said rodent comprises at least 2 ppm fipronil.

106. A method according to claim 105 wherein the bait composition provided for ingestion by said rodent comprises at least 10 ppm fipronil.

107. A method according to claim 106 wherein the bait composition provided for ingestion by said rodent comprises at least 40 ppm fipronil.

108. A method according to claim 103 wherein the bait composition provided for ingestion by said rodent comprises from 10 to 250 ppm rodenticide.

109. A method according to claim 108 wherein the bait composition provided for ingestion by said rodent comprises from 20 to 100 ppm rodenticide.

110. A method according to claim 109 wherein the bait composition provided for ingestion by said rodent comprises from 25 ppm to 50 ppm rodenticide.

111. A method according to claim 103 wherein the bait composition provided for ingestion by said rodent comprises a rodenticide selected from the group consisting of brodifacoum and difethialone.

112. A method according to claim 111 wherein the bait composition provided for ingestion by said rodent comprises brodifacoum in an amount of about 50 ppm.

113. A method according to claim 111 wherein the bait composition provided for ingestion by said rodent comprises difethialone in an amount of about 25 ppm.
